(19) United States
(12) Patent Application Publication
(10) Pub. No.: US 2004/0106427 A1
(43) Pub. Date: Jun. 3, 2004

(54) Control device with remote control of a cellular phone for a component of the cabin in a motor vehicle

(75) Inventors: Andrea Collavo, Montebelluna (TV) (IT); Bruno Zalla, Sacile (PN) (IT)

Correspondence Address: John S. Egbert, Harrison & Egbert, 7th Floor, 412 Main Street, Houston, TX, 77002, US

(73) Assignee: PLASTAL SPA, Pordenone (IT)

(21) Appl. No.: 10/602,237

(22) Filed: Jun. 24, 2003

(30) Foreign Application Priority Data
Jun. 27, 2002 (IT) TV2002A000072

(51) Int. Cl. H04M 1/00

(52) U.S. Cl. 455/550.1; 455/575.9

(57) ABSTRACT

A control device with remote control of the cellular mobile phone for a component in the cabin of a motor vehicle consisting in a container in which, in correspondence of the side facing the car's occupants,

a microphone

at least an on/off voice activation switch

a display

and a basic keyboard

are foreseen, said container being internally arranged to house a speaker and also a electronic component including a transmitting/receiving system able to communicate with a cellular pone provided with a wireless communication system.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

This invention refers to an accessory-device with remote control of the cellular phone for a component in the cabin of car.

### BACKGROUND OF THE INVENTION

The invention is used particularly, but not exclusively, in the field of motor vehicles in order to allow wireless communication to and from the cabin.

Cellular telephony, of which the mobile phone is the principal element, is well known. Since its arrival on the market, its progress in the sector has been remarkable. They, however, have mainly regarded the apparatus itself and the functions it carries out, without taking into account the implications linked to its use.

The capillary diffusion of the mobile phone has made it indispensable, so much so that its very use is frequent also where it would not be desirable, because of the fact that it jeopardizes the attention of the user. This refers more in particular to the use, surely unsafe, within cars. And in fact, the mobile phone, due to it being an easily carried object used for communication, accompanies almost always its rightful owner, therefore also in the car. Having it at disposal, unfortunately also when driving, leads the driver to enjoy the use of its services. Therefore it is nowadays not rare to see people using their mobile phones, often in a lively manner, while driving. It is to be said, in addition, that its use does not depend solely on the will of the apparatus's owner, but being also a receptive medium, when it is switched on it is able to receive incoming calls even involuntarily, which, consequently, solicit the attention of the driver.

The use, shall we say indiscriminate, of a mobile phone, also in unhappy conditions as while driving, is statistically a cause of accidents. The reasons are absolutely well known, so much so that recently some public administrations have decided to severely sanction those who use their phone while driving without installing into their car a hands-free set or other such means.

These initiatives, also if valuable in the aim, appear to have little effect on resolving the problem; this is because they do not affront in a specific way the main reason why it is not advisable to drive while using a telephone. Summarizing in short, the attention of a driver, whether making a call or receiving one, is substantially distracted, even if for few fractions of a second, from the road.

From a practical aspect, what above mentioned is absolutely indisputable.

On the other hand, the solutions that are nowadays offered by the market do not provide valid alternatives. For example, with in-car telephones, such as those installed in top of the range cars, the phone is integrated into components within the cabin, often in the central armrest. Moreover, they are equipped with the hands-free option and offer all the common functions of mobile telephones. They are usually dangerous installations because they compel the user to take his/her eyes off the road in order to look back down on the display. Besides, despite them being integrated, their assembly requires difficult procedures, both on the structure of the cabin and on the overall plant design and installation, all of the situations which are somewhat complex under the executive profile.

Alternative solutions deal with providing integrated systems, which, besides the car phone with its GSM module and SIM card, include:

CD/DVD reader;

Car radio;

Navigator; and

Voice activation

They are first generation systems, which are usually fitted into the dashboard of the motor vehicle in a more or less high central position that coincides with the cabin's median axis above the central tunnel. They are equipped with an onboard video through which all the functions are shown, and with an alphanumeric keyboard which can be operated using key caps or alternatively using a touch-screen technology directly on the screen.

More advanced systems from more recent generations provide, in addition to the afore mentioned characteristics, a complete remote control and a control on the steering wheel.

These last systems fall into the typology of apparatuses dealing with the problem of avoiding, as far as possible, distracting the driver, even if momentarily, in the research into the function keys which are present on the telephone handset, providing the opportunity to use a remote control. In this case, the driver is able to make and receive calls thanks to the remote control, operating on the keyboard on the steering wheel, which intuitively is the position closest to where the driver usually places his/her hands.

But out of the main causes of distraction, there is not only the position of the hands, but above all the displacement of the driver's eyes from the horizon to said remote devices, especially when operating the controls on the dashboard, in the case of reading the information on the onboard video and also in the eventual case of handling the telephone.

And finally, also the sun visors are known. These car components are usually positioned facing both the driver's and passenger's sides. These are characteristically wing shaped and generally hinged along the front panel and in correspondence with the line that joins the roof to the windscreen. The main function of the sun visors is, thanks to them being adjustable, to block out the sun's rays and prevent them from distracting the driver. More advanced solutions will also provide a courtesy light and even a document storage compartment.

### STATE OF THE ART

During the research phase of the safest positions for the control devices for operating the mobile phone, it became apparent that the fundamental requirement would be not to lower the driver's gaze but only to rotate it laterally, or even to raise it slightly while keeping it always on the road. The conclusion has been reached that in every case a lateral movement, for example towards the rear view mirror, is generally quicker and always allows the driver to concentrate on what is happening on the road.

In light of the following considerations, some, for example U.S. Ser. No. 2002/0,004,416 (Baratono), intended to create a so-called hands-free system that combines a mobile phone or telephonic unit with a rear view mirror for motor vehicles. More in particular, it is forseen a fitting that incorporates, in the top part of the windscreen, a rear view mirror inside of which it will be possible to introduce a removable mobile-phone for making and receiving phone calls. Said fitting is provided with an electrical circuit for connecting the mobile phone. In correspondence with the rear view mirror side, a keyboard with a speaker and a microphone effectively connected to the mobile phone for the use of the hands-free function is provided on one side.

GB2356312 (Abbas) describes a solution very similar to the previous one. More in detail, it can be said that this solution differs from the previous one because of the positioning of the keyboard which, in this case, is placed linearly and in sequence along the lower side of the rear view mirror. Near the keyboard there is a longitudinal display to visualize, always linearly, the information.

### DRAWBACKS

The above mentioned proposals for a complex rear view mirror highlighted that, if from one side they represented a significant progress, from the other they seemed very limited. This is due to the fact that the essential condition needed for their working is the physical union of the mobile phone to the suspended structure, which provides the relative fitting and includes said rear mirror on one side.

Effectively the operation may appear to be simple. However, apart from the inconvenience due to the awkward position for the connection obstructed by the inclination of the windscreen, it has always to be turned before leaving the vehicle. Introducing the mobile phone into the fitting in the rear view mirror while driving, would cancel the advantages of the solution.

It is nonetheless evident that disconnecting the mobile phone from the described rear view mirror fitting every time the driver leaves the car, and likewise reconnecting it every time the driver gets back in, is an inconvenience.

Yet the inconveniences can also be referred to the difficulty in preventing the unsatisfactory connections of the mobile phone to the fitting, which under stress and while in a hurry will not always guarantee a good connective capacity.

Object of the present invention is also to avoid said inconveniences.

### BRIEF SUMMARY OF THE INVENTION

This and other objects are achieved with this invention according to the characteristics as in the including claims, solving the arising problems with a control device with remote control of the cellular mobile phone for a component of the cabin in a motor vehicle, consisting in a container in which, on the side facing the occupants of the car,

a microphone

at least an ON/OFF Voice Activation switch

a display

and a basic keyboard, are provided, said container is internally arranged for housing a speaker and also an electronic component inluding a transmitting and receiving system able to communicate with a mobile phone provided with a wireless communication system.

### ADVANTAGES

In this way, through the considerable creative contribution, which effects have allowed to reach a considerable technical progress, different advantages are achieved.

A first object is to avoid the physical association between the mobile phone and the rear view mirror. The benefit of such an object is to allow the activation of the functions on the remote control device simply by entering the car, whereas the simple exit from the range of the transmitter automatically excludes and deactivates the remote control.

A second object is to position the remote control device and all its main functions in a position that interferes as little as possible with driving the car with regards to the previous solutions. The trajectory of the driver's eyes is optimized yet even more when the remote control device is attached to the sun visor, which is even closer and in axis with the horizon with respect to the rear view mirror.

A third object is the possibility to construct the remote control device as an accessory which can be connected and disconnected by the user according to its needs and positioned where desired and, in some solutions, even independently of the specific power supply fitting foreseen by the car's constructor.

Another object is to provide a remote control device with its own source of accumulation and power supply, in order to function independently from the car's supply.

A further object is also to allow the use of the remote control device to people not possessing a mobile phone of the last generation, which uses wireless communication.

These and other advantages and objects will be apparent from the following specific description of some preferred embodiments and from the included schematic drawings, which are provided solely for the purpose of illustrating and not for limitating the invention.

### BRIEF DESCRIPTION OF THE VIEW OF THE DRAWING

FIG. 1 is a perspective view of a rear view mirror, with a remote control device for cellular telephony integrated into its lower part.

FIG. 2 is a perspective view of a variation of the rear View mirror in FIG. 1, with a detachable remote control device for cellular telephony shown on its lower part.

FIG. 3 is a perspective view of a sun visor with a remote control device for cellular telephony along its lower border, that is detachable from the support structure.

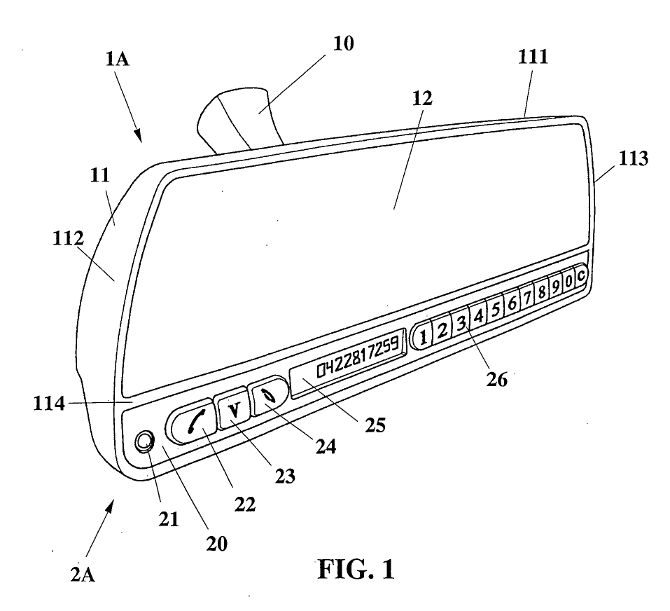

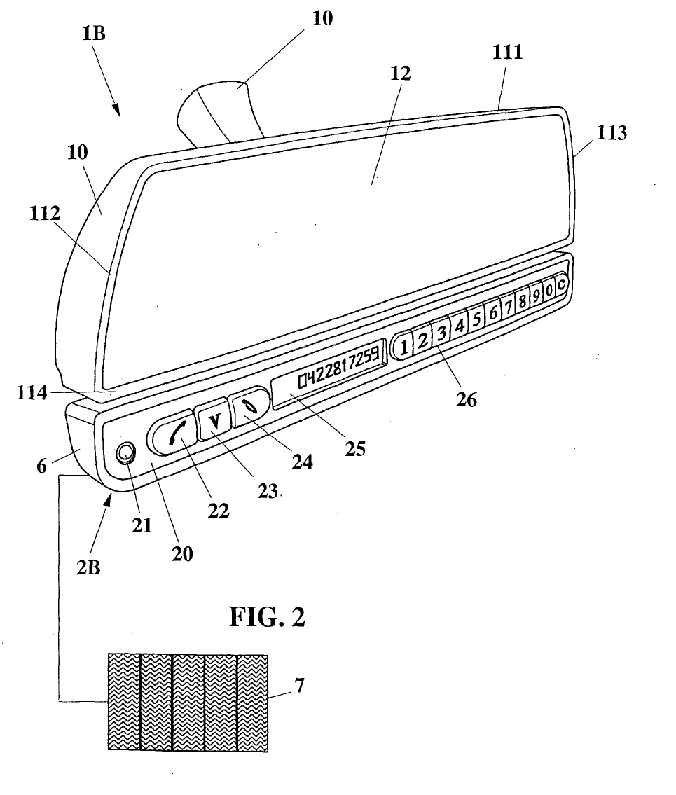

Finally, FIG. 4 represents a perspective view of a non-wireless mobile phone connected to a wireless interface device in order to communicate to and from the remote control device.

### DETAILED DESCRIPTION OF THE INVENTION

Also referring to the figures, it can be seen that a structure of a component for the cabin of a motor vehicle 1A, 1B is composed by a rear view mirror 12 and also a remote control device 2A, 2B.

Said component for the cabin of a motor vehicle 1A uses a support element 10 in the form of an arm, which supports a protruding shell 11 that serves as a container. The rear part of the shell 11, facing the windscreen, is therefore shaped in a substantially harmonious way, while the front part, facing the inside of the cabin, has an essentially flat surface. The front part is characterised by the insertion of a front mirror 12. In this case, the area of the rear view mirror 12, of the convertible type so as not to dazzle the driver, consists of a longitudinal strip which extends from the upper border 111 of the shell 11 up to almost three quarters of the front part, while longitudinally the mirror 12 extends from one side 112 to the other 113 of the motor vehicle cabin component 1A. In correspondence with the base of the mirror 12 separated by a parting 114, the remote control device 2A integrated into the motor vehicle cabin component 1A is foreseen. In more detail, in the front part of the motor vehicle cabin component 1A there is a technical mask 20 attached lengthwise all of the lower residual area. In even more detail, said technical mask 20 of the control device with integrated remote control 2A is provided with the following elements, positioned in a linear manner and from left to right, respectively:

a microphone 21

an ON switch 22

a voice activator 23

an OFF switch 24

a display 25

an alphanumeric keyboard 26.

Elements 22, 23, 24, 25 and 26 consist in typically keys protruding from the technical mask 20 of the control device with integrated remote control 2A, while the display 25 is of the illuminated type.

The inside part of the shell 11 is structured in a rational way to allow the fitting of the electrical and electronic part. In more detail, besides a speaker, it includes a transmitting/receiving device which communicates, in a remote way, with a cellular phone of the wireless communication type, as for example a cellular phone equipped with Bluetooth technology.

When a non-wireless technology cellular phone is used, the interaction of an additional transmitting/receiving device 3 is necessary. This device is on one hand connectable, using a universal attachment 31, to the traditional cellular phone 4. On the other hand, the transmitting/receiving module 3 comes with a socket 32 for the connection of a plug 5 attached to a power supply by means of a traditional, cigarette lighter socket.

In an alternative and preferred solution, with regards to the previous proposal, the control device with remote control 2B consists in a removable body 6 with respect to structure 10 of the component 1B that supports the rear view mirror 12. In more detail, the remote control device 2B includes a containing body 6, which protrudes along the whole length of the structure 10, which is externally provided with reciprocal coupling means for connection to the portion of the shell 10 of component 1B. Also in this solution, a technical mask 20 covers the front part of the containing body 6 where the following elements are positioned in a linear manner, from left to right respectively:

a microphone 21

an ON switch 22

a voice activator 23

an OFF switch 24

a display 25

an alphanumeric keyboard 26.

Similarly, elements 22, 23, 24, 25 and 26 consist of typically keys protruding from the technical mask 20 of the control device with integrated remote control 2A, while the display 25 is of the illuminated type.

The inside part of the containing body 6 is structured in a rational way to allow the fitting of the electrical and electronic part. In more detail, besides a speaker, it includes a transmitting/receiving device, which communicates in a remote way with a cellular phone of the wireless communication type, as for example a cellular phone equipped with Bluetooth technology.

In a third solution it is possible to structure the inside of the shell 10 similarly to shell 11 in such a way as to house at least one part of the electrical and electronic component, including the transmitting/receiving device, with the necessary power supply to allow the control keys and instruments 21, 22, 23, 24, 25 and 26 on the technical mask 20 of the containing body to communicate with the wireless cellular phone.

With regards to the power supply of the control device with integrated 2A and non-integrated remote control 213, it can be obtained using the already existing lines or alternatively by providing an individual power supply of the solar cell type 7, with an eventual internal accumulator, which supplies power only to the control device with remote control 2A or 2B.

In another preferred solution, the control device with remote control, both of type 2A or 213, can be attached to a sun visor 8.

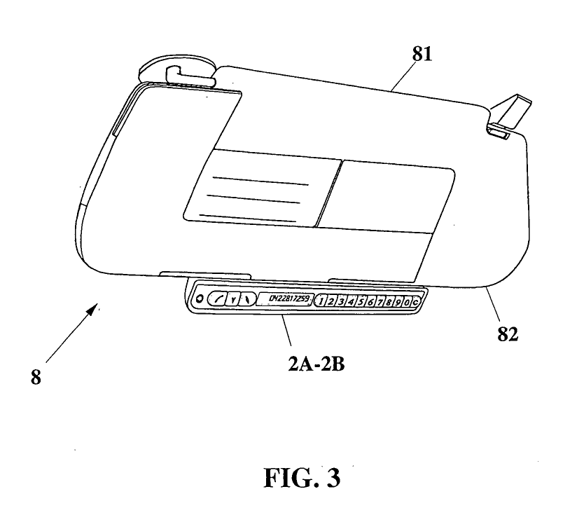

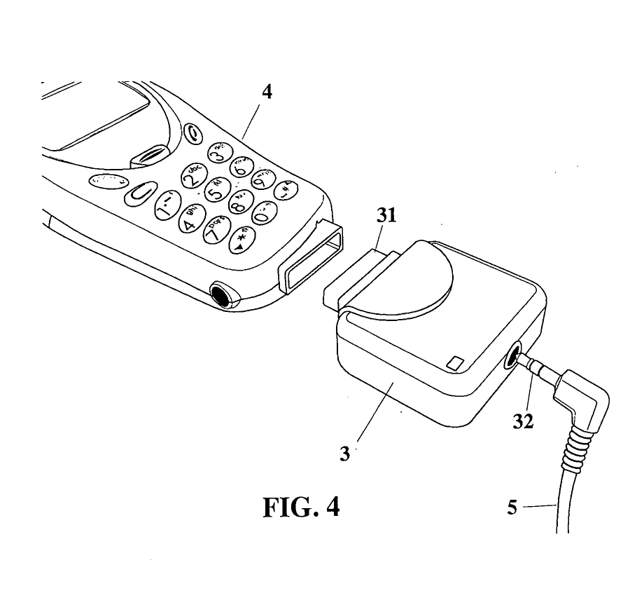

More in particular, in FIG. 3 a sun visor 8 is illustrated. This consists of a flat structure, partially obscuring the horizon from the driver's view, and conventionally positioned along the upper border 81, thus resulting longitudinally hinged. It is structured so as to be re-positioned and even to be un-hooked on one side in order to be transferred across onto the side of the driver's window. Along the lower border 82 of the sun visor 8, the removable control device with remote control is attached. Alternatively, the control device with remote control 2A can be integrated into that same structure in correspondence to the lower end of the sun visor 8.

I claim:

1. Control device with remote control of a cellular mobile phone for a component inside the cabin of a motor vehicle, characterised in that it consists of a container, in which along one side the following control elements are foreseen:
a microphone at least an ON/OFF/Voice Activation switch a display
and a basic keyboard, said container is arranged to internally house a speaker and also an electronic component including a transmitting/receiving system able to communicate with a cellular phone provided with a wireless communication system.

2. Control device with remote control of the mobile phone according to claim 1, characterised in that the container is integrated in a component that also includes the rear view mirror.

3. Control device with remote control of a cellular mobile phone according to claim 1, characterised in that the container is integrated into a sun Visor.

4. Control device with remote control of the mobile phone according to claim 1, characterised in that the container is detachable from the component housing the rear view mirror.

5. Control device with remote control of the mobile phone according to claim 1, characterised in that the container is detachable from the sun visor.

6. Control device with remote control of the mobile phone according to the previous claims, characterised in that it includes a containing body protruding lengthwise with respect to the component of the inside of the car, with a technical mask covering the front part of the containing body where the following elements, from left to right respectively, are linearly provided:
a microphone an ON switch a voice activator an OFF switch
a display
an alphanumeric keyboard.

7. Control device with remote control of the mobile phone according to claims 1, 4, 5 and 6, characterised in that reciprocal coupling means to shell portion of the inside component for the cabin are externally provided.

8. Control device with remote control of the mobile phone according to the previous claims, characterised in that the power supply of the control device with remote control is provided through a low tension dedicated line in the car component, and/or providing an individual power supply of the solar cell type, with an eventual internal accumulator.

9. Control device with remote control of the mobile phone according to the previous claims, characterised in that it communicates with a cellular mobile phone that uses an additional wireless transmitting/receiving interactive module, which on one hand connectable to said cellular phone by a universal attachment, while on the other hand is provided with a socket for the connection of a power supply plug by means of a traditional cigarette lighter socket.
